(19) United States
(12) Patent Application Publication
(10) Pub. No.: US 2014/0078224 A1
(43) Pub. Date: Mar. 20, 2014

(54) INKJET PRINT HEAD

(71) Applicant: SAMSUNG ELECTRO-MECHANICS CO., LTD., Suwon (KR)

(72) Inventors: Yoon Sok PARK, Suwon (KR); Seung Joo Shin, Suwon (KR); Byung Hun Kim, Suwon (KR); Hwa Sun Lee, Suwon (KR)

(73) Assignee: SAMSUNG ELECTRO-MECHANICS CO., LTD., Suwon (KR)

(21) Appl. No.: 13/741,852

(22) Filed: Jan. 15, 2013

(30) Foreign Application Priority Data
Sep. 20, 2012 (KR) 10-2012-0104398

(51) Int. Cl. B41J 2/045

(52) U.S. Cl. CPC B41J 2/045
USPC 347/71

(57) ABSTRACT

There is provided an inkjet print head, including: a first pressure chamber connected to a first common channel; a second pressure chamber connected to a second common channel; a connection channel connecting the first pressure chamber to the second pressure chamber; and a nozzle formed in the first pressure chamber or the second pressure chamber.

### CROSS-REFERENCE TO RELATED APPLICATIONS

This application claims the priority of Korean Patent Application No. 10-2012-0104398 filed on Sep. 20, 2012, in the Korean Intellectual Property Office, the disclosure of which is incorporated herein by reference.

### BACKGROUND OF THE INVENTION

1. Field of the Invention

The present invention relates to an inkjet print head, and more particularly, to an inkjet print head capable of improving ink discharge efficiency through ink circulation.

2. Description of the Related Art

An inkjet print head may print a desired figure, shape or pattern by discharging micro-sized ink droplets (or a liquid industrial material) through a nozzle.

However, the above-mentioned inkjet print head has a disadvantage in that a discharge performance thereof may be degraded over a long period of time. For example, since foreign objects or air bubbles contained in ink may interrupt the discharge of ink through nozzles, they may degrade discharge efficiency of the inkjet print head.

Therefore, the development of an inkjet print head capable of decreasing the degradation of discharge efficiency of the inkjet print head due to the foreign objects or the air bubbles contained in the ink is required.

Meanwhile, examples of the related art associated with the inkjet print head include Patent Documents 1 and 2. Patent Document 1 discloses the use of a plurality of actuators, and Patent Document 2 discloses that the ink is pressure-fed in one direction using a plurality of actuators.

However, these Patent Documents do not only recognize a problem due to foreign objects or air bubbles contained in ink, but also do not disclose any configuration for solving the above-mentioned problem.

### RELATED ART DOCUMENT

(Patent Document 1) JP 2010-221443 A
(Patent Document 2) JP 2008-184884 A

### SUMMARY OF THE INVENTION

An aspect of the present invention provides an inkjet print head capable of improving ink discharge efficiency by smoothly circulating ink.

According to an aspect of the present invention, there is provided an inkjet print head, including: a first pressure chamber connected to a first common channel; a second pressure chamber connected to a second common channel; a connection channel connecting the first pressure chamber to the second pressure chamber; and a nozzle formed in the first pressure chamber or the second pressure chamber.

The first pressure chamber and the second pressure chamber may be serially connected to one another.

The first pressure chamber and the second pressure chamber may have different volumes.

The inkjet print head may further include: a first actuator generating pressure in the first pressure chamber; and a second actuator generating pressure in the second pressure chamber.

The first actuator and the second actuator may have different sizes.

The first common channel may be connected to an ink supplying part, and the second common channel may be connected to an ink recovering part.

The ink supplying part and the ink recovering part may be connected to one another so that ink may be circulated therebetween.

According to another aspect of the present invention, there is provided an inkjet print head, including: a first pressure chamber connected to a first common channel; a second pressure chamber connected to a second common channel; a third pressure chamber connected to the first pressure chamber and the second pressure chamber; and a nozzle formed in the third pressure chamber.

The third pressure chamber may have a different volume from that of the first pressure chamber or the second pressure chamber.

The inkjet print head may further include: a first actuator generating pressure in the first pressure chamber; a second actuator generating pressure in the second pressure chamber; and a third actuator generating pressure in the third pressure chamber.

The third actuator may have a different size from that of the first actuator or the second actuator.

The first common channel may be connected to an ink supplying part, and the second common channel may be connected to an ink recovering part.

The ink supplying part and the ink recovering part may be connected to one another so that ink may be circulated therebetween.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view showing an inkjet print head according a first embodiment of the present invention;

FIG. 2 is a view describing an operation of the inkjet print head shown in FIG. 1;

FIGS. 3 through 7 are views describing another operation of the inkjet print head shown in FIG. 1;

FIG. 8 is a cross-sectional view showing an inkjet print head according a second embodiment of the present invention;

FIG. 9 is a cross-sectional view showing an inkjet print head according a third embodiment of the present invention;

FIG. 10 is a cross-sectional view showing an inkjet print head according a fourth embodiment of the present invention; and

FIGS. 11 through 15 are views describing an operation of the inkjet print head shown in FIG. 10.

### DETAILED DESCRIPTION OF THE EMBODIMENTS

In the inkjet print head according to the related art, ink only flows in one direction (from a common channel to a nozzle), such that a nozzle obstruction phenomenon due to foreign objects or air bubbles may occur in the nozzle.

In the present invention, an object of which is to solve the above-mentioned problem, a first pressure chamber and a second pressure chamber are connected to one another so that ink is circulated in an inkjet print head.

In the inkjet print head having the above-described ink circulation structure according to the embodiment of the present invention, the ink is continuously circulated so that the phenomenon in which the foreign objects or air bubbles are concentrated in the nozzle may be alleviated, whereby the nozzle obstruction phenomenon in the nozzle may be decreased.

Further, according to the embodiment of the present invention, a plurality of actuators respectively provided with a plurality of pressure chambers generate pressure, whereby a discharge speed and a discharge force of the ink may be improved.

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components may be exaggerated for clarity, and the same reference numerals will be used throughout to designate the same or like components.

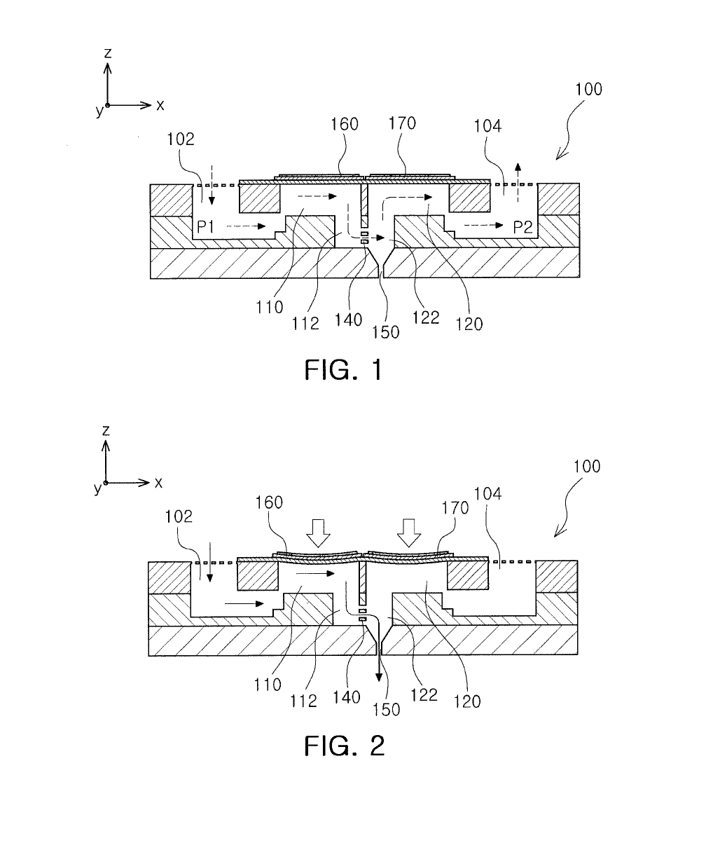

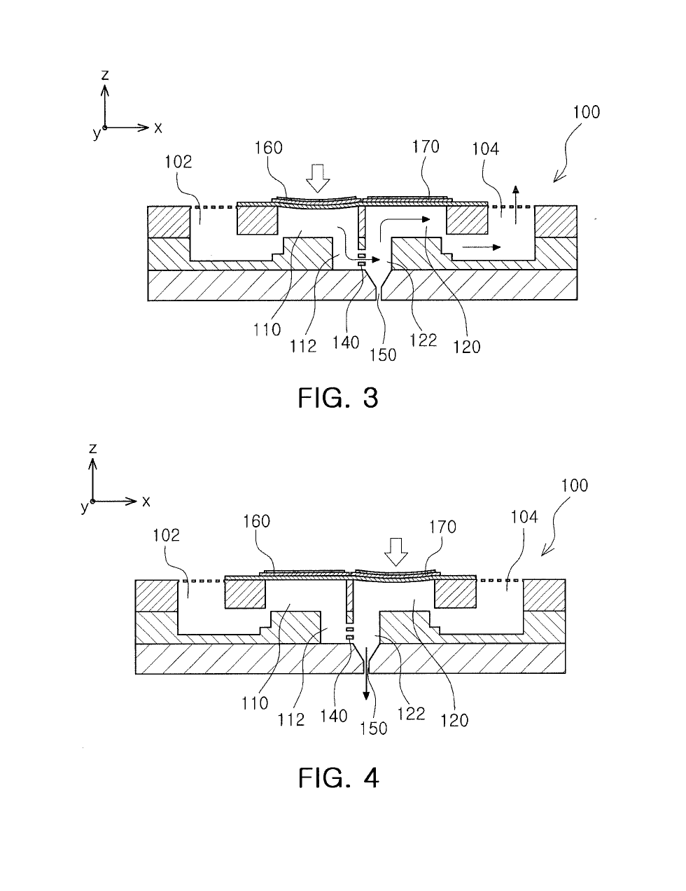

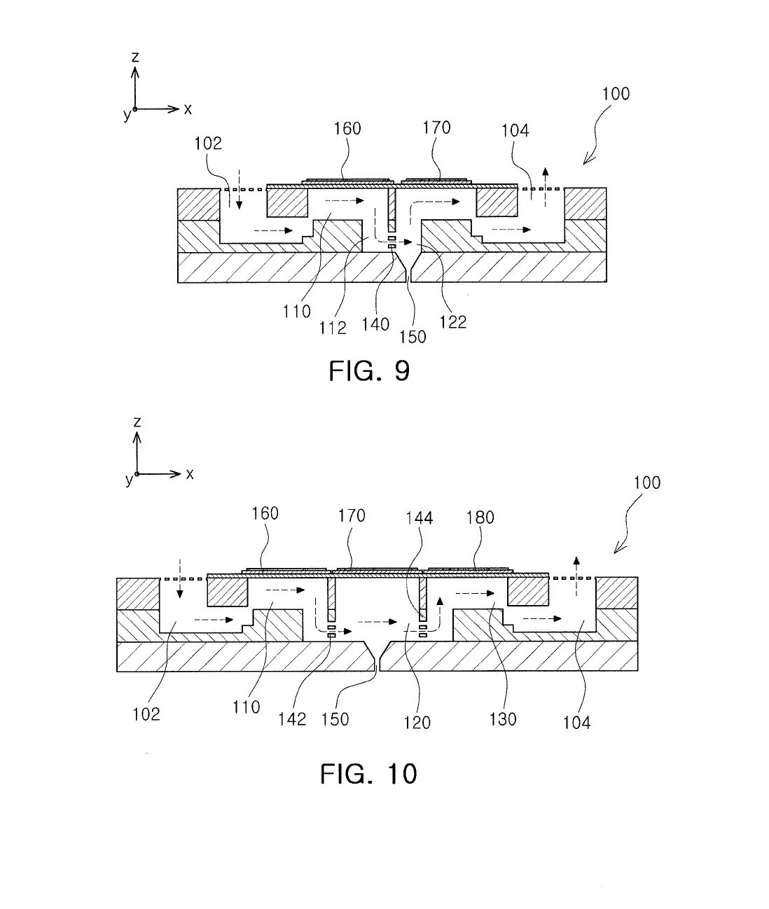

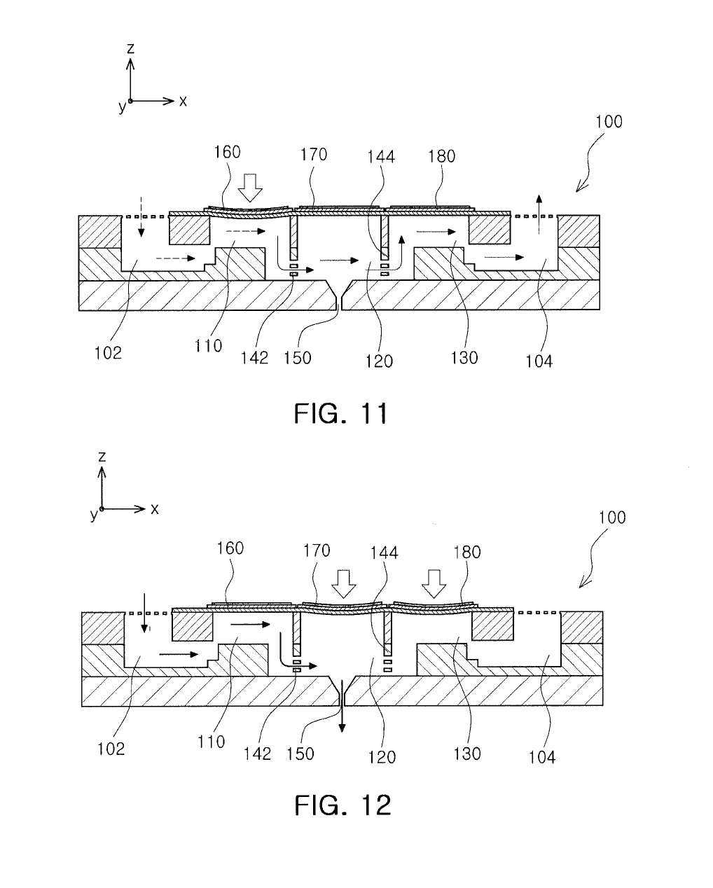

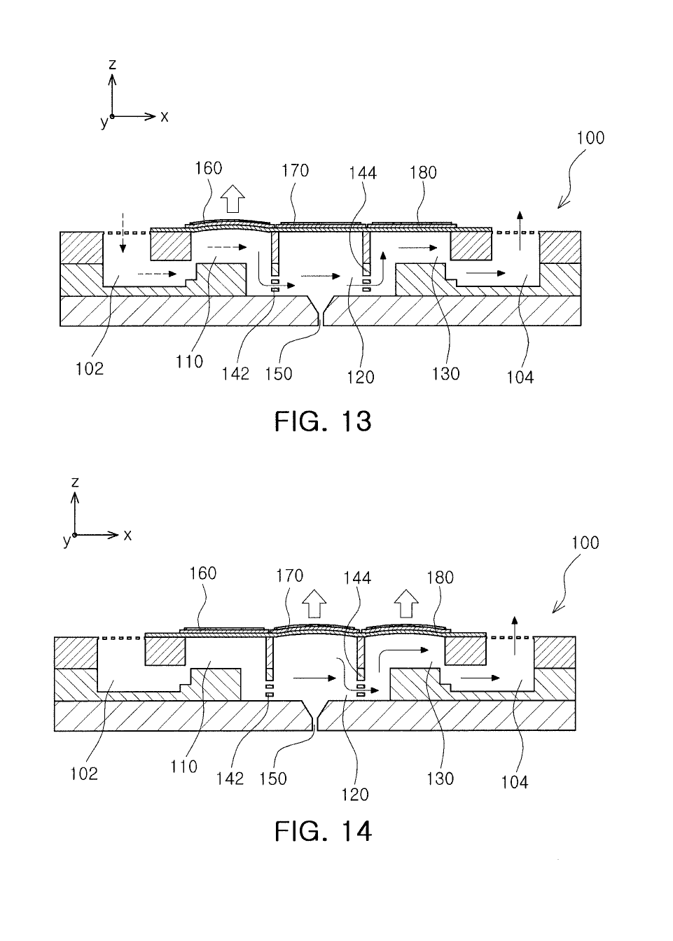

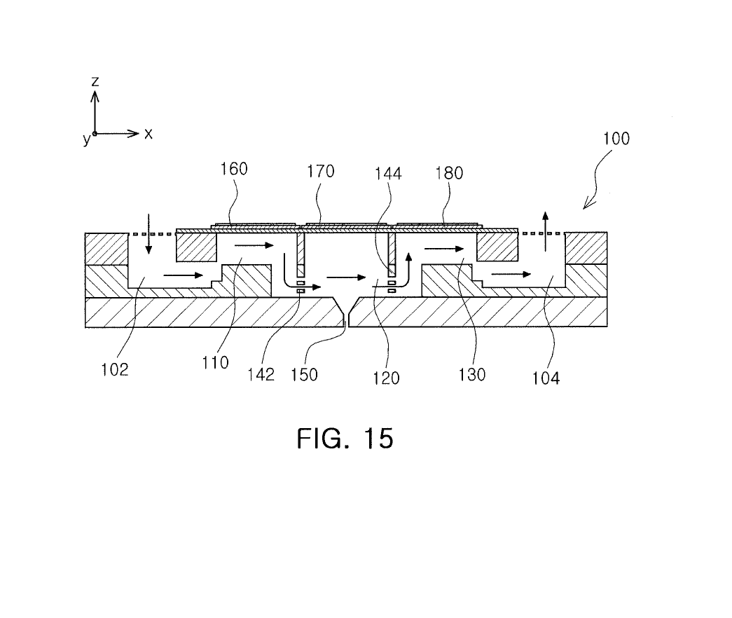

FIG. 1 is a cross-sectional view showing an inkjet print head according a first embodiment of the present invention; FIG. 2 is a view describing an operation of the inkjet print head shown in FIG. 1; FIGS. 3 through 7 are views describing another operation of the inkjet print head shown in FIG. 1; FIG. 8 is a cross-sectional view showing an inkjet print head according a second embodiment of the present invention; FIG. 9 is a cross-sectional view showing an inkjet print head according a third embodiment of the present invention; FIG. 10 is a cross-sectional view showing an inkjet print head according a fourth embodiment of the present invention; and FIGS. 11 through 15 are views describing an operation of the inkjet print head shown in FIG. 10.

An inkjet print head according to a first embodiment of the present invention will be described with reference to FIG. 1.

An inkjet print head 100 according to the first embodiment of the present invention may include a first common channel 102, a second common channel 104, a first pressure chamber 110, a second pressure chamber 120, a connection channel 140, and a nozzle 150. In addition, the inkjet print head 100 may include a first actuator 160 and a second actuator 170.

The first common channel 102 may be elongated in a first direction (a Y axis direction of FIG. 1) of the inkjet print head 100. The first common channel 102 formed as described above may be connected to an ink supplying part in which ink is stored. Therefore, the ink may be continuously supplied through the first common channel 102.

The first common channel 102 may have a first pressure P1 having a predetermined level formed therein. The first pressure P1 may be higher than atmospheric pressure. In addition, the first pressure P1 may be higher than pressure of the first pressure chamber 110. Therefore, the ink in the first pressure chamber 110 may be moved to the second pressure chamber 120 without flowing backwardly into the first common channel 102.

The second common channel 104 may be elongated in a first direction (the Y axis direction of FIG. 1) of the inkjet print head 100. That is, the second common channel 104 may be formed in parallel with the first common channel 102. The second common channel 104 formed as described above may be connected to an ink recovering part in which the ink is recovered. Therefore, the ink may be continuously recovered through the second common channel 104.

The second common channel 104 may have a second pressure P2 having a predetermined level formed therein. The second pressure P2 may be lower than atmospheric pressure. In addition, the second pressure P2 may be lower than pressure of the second pressure chamber 120. Therefore, the ink in the second pressure chamber 120 may be moved to the second common channel 104 without flowing backwardly into the first pressure chamber 110.

The first pressure chamber 110 may be formed upwardly on one side of the first common channel 102 (an X axis direction of FIG. 1). The first pressure chamber 110 may have a predetermined volume and may store the ink supplied from the first common channel 102.

The first pressure chamber 110 may include a first damper 112, extended downwardly (the Y axis direction of FIG. 1). The first damper 112 may alleviate a phenomenon in which the ink in the first pressure chamber 110 is rapidly moved to the second pressure chamber 120. However, the first damper 112 may be omitted as necessary.

Meanwhile, although not shown, the first pressure chamber 110 and the first common channel 102 may be connected to one another by a channel having a restrictor shape.

The second pressure chamber 120 may be formed downwardly on one side of the second common channel 104 (the X axis direction of FIG. 1). The second pressure chamber 120 may have a predetermined volume and may store the ink moved from the first pressure chamber 110.

The second pressure chamber 120 may include a second damper 122, extended downwardly (the Y axis direction of FIG. 1). The second damper 122 may alleviate a phenomenon in which the ink is rapidly moved from the first pressure chamber 110 to the second pressure chamber 120. However, the second damper 122 may be omitted as necessary.

Meanwhile, although not shown, the second pressure chamber 120 and the second common channel 104 may be connected to one another by a channel having a restrictor shape.

The connection channel 140 may be formed between the first pressure chamber 110 and the second pressure chamber 120. The connection channel 140 formed as described above may connect the first pressure chamber 110 and the second pressure chamber 120 to one another.

The connection channel 140 may be formed in the pressure chambers 110 and 120 or the dampers 112 and 122. For example, the connection channel 140 may connect the first pressure chamber 110 and the second pressure chamber 120 to one another, or may connect the first damper 112 and the second damper 122 to one another.

The nozzle 150 may be formed in the second pressure chamber 120. The nozzle 150 formed as described above may discharge the ink stored in the first pressure chamber 110 or the second pressure chamber 120 to the outside.

The nozzle 150 may have a cross sectional diameter decreasing downwardly (a Z axis direction of FIG. 1) of the inkjet print head 100, as shown in FIG. 1. This shape may be useful for discharging a fixed quantity of ink.

For reference, although the nozzle 150 is illustrated to be formed in the second pressure chamber 120, the nozzle 150 may be formed in the first pressure chamber 110, as necessary.

The first actuator 160 may be formed on the first pressure chamber 110. The first actuator 160 may be operated according to an electrical signal and may generate positive pressure or negative pressure in the first pressure chamber 110.

The first actuator 160 may include a piezoelectric element and upper and lower electrode members. More specifically, the first actuator 160 may be a laminated structure in which the upper and lower electrode members are disposed, having the piezoelectric element therebetween.

The lower electrode member may be formed on an upper surface of a vibration plate and may be made of one or more conductive metal materials. For example, the lower electrode member may be formed of two metal members made of titanium (Ti) and platinum (Pt).

The piezoelectric element may be formed on the lower electrode member. More specifically, the piezoelectric element may be thinly formed on a surface of the lower electrode member by a screen printing method, a sputtering method, or the like. The piezoelectric element may be made of piezoelectric materials. For example, the piezoelectric element may be made of a ceramic (for example, PZT) material.

The upper electrode member may be formed on an upper surface of the piezoelectric element. The upper electrode member may be made of any one of Pt, Au, Ag, Ni, Ti and Cu.

The first actuator 160 configured as described above may be tensioned and contracted according to the electrical signal and may generate pressure in the first pressure chamber 110.

The second actuator 170 may be formed on the second pressure chamber 120. The second actuator 170 may be operated according to an electrical signal and may generate positive pressure or negative pressure in the second pressure chamber 120.

The second actuator 170 may include a piezoelectric element and, similar to the first actuator 160. More specifically, the second actuator 170 may be a laminated structure in which the upper and lower electrode members are disposed, having the piezoelectric element therebetween.

The lower electrode member may be formed on an upper surface of a vibration plate and may be made of one or more conductive metal materials. For example, the lower electrode member may be formed of two metal members made of titanium (Ti) and platinum (Pt). For reference, the lower electrode member of the second actuator 170 may be the same as that of the first actuator 160.

The piezoelectric element may be formed on the lower electrode member. More specifically, the piezoelectric element may be thinly formed on a surface of the lower electrode member by a screen printing method, a sputtering method, or the like. The piezoelectric element may be made of piezoelectric materials. For example, the piezoelectric element may be made of a ceramic (for example, PZT) material.

The upper electrode member may be formed on an upper surface of the piezoelectric element. The upper electrode member may be made of any one of Pt, Au, Ag, Ni, Ti and Cu.

The second actuator 170 configured as described above may be tensioned and contracted according to the electrical signal and may generate pressure in the second pressure chamber 120.

In the inkjet print head 100 configured as described above, the ink may continuously flow in a sequence of the common channel 102, the first pressure chamber 110, the second pressure chamber 120, and the second common channel 104. Therefore, the phenomenon in which foreign objects or air bubbles contained in the ink are concentrated in the nozzle 150 to thereby degrade discharge characteristics of the nozzle 150 may be alleviated.

Meanwhile, although not shown in FIG. 1, the first common channel 102 and the second common channel 104 may be interconnected. In this case, there may be an ink circulation structure in which the ink supplied from the first common channel 102 is re-introduced into the first common channel 102 through the second common channel 104.

A filter filtering the foreign objects contained in the ink and a degassing device removing the air bubbles contained in the ink may be installed between the first common channel 102 and the second common channel 104. As described above, the inkjet print head 100 including the filter and the degassing device may remove the foreign objects and the air bubbles from the ink, such that the nozzle obstruction phenomenon of the nozzle 150 may be effectively alleviated, whereby characteristics and performance of printing quality may be improved.

Operations of the inkjet print head according to the first embodiment of the present invention will be described with reference to FIGS. 2 to 7.

The inkjet print head 100 according to the first embodiment of the present invention may be operated in two methods. One method may be a first operating method in which the first actuator 160 and the second actuator 170 are simultaneously operated and the other method may be a second operating method in which the first actuator 160 and the second actuator 170 are operating, while having a time difference therebetween.

First, the first operating method of the inkjet print head 100 will be described with reference to FIG. 2.

The first operating method may discharge the ink using the first actuator 160 and the second actuator 170 being simultaneously operated. That is, in the first operating method, the first actuator 160 and the second actuator 170 are simultaneously operated in a state in which the first pressure chamber 110 and the second pressure chamber 120 are filled with the ink, thereby allowing the ink in the first pressure chamber 110 or the second pressure chamber 120 to be discharged through the nozzle 150. An amount of the ink discharged through the nozzle 150 may be equal to or less than the volume of the first pressure chamber 110 or that of the second pressure chamber 120. Meanwhile, the ink which is not discharged through the nozzle 150 may be moved to the second common channel 104 through the second pressure chamber 120.

Next, the second operating method of the inkjet print head 100 will be described with reference to FIGS. 3 through 7.

The second operating method may operate the first actuator 160 and the second actuator 170 sequentially. More specifically, the second operating method may discharge the ink by which the first actuator 160 is operated and the second actuator 170 is then operated. Here, a flow of the ink according to the operations of the actuators 160 and 170 may be sequentially performed as shown in FIGS. 3 through 7.

First, when the first actuator 160 is operated to thereby apply pressure to the first pressure chamber 110, the ink in the first pressure chamber 110 may be moved to the second pressure chamber 120. In this case, when the second actuator 170 is operated while having a predetermined time difference between the first actuator 160 and the second actuator 170 to thereby apply pressure to the second pressure chamber 120, the ink moving from the first pressure chamber 110 to the second pressure chamber 120 may be discharged through the nozzle 150 and the ink remaining in the second pressure chamber 120 may be moved to the second common channel 104.

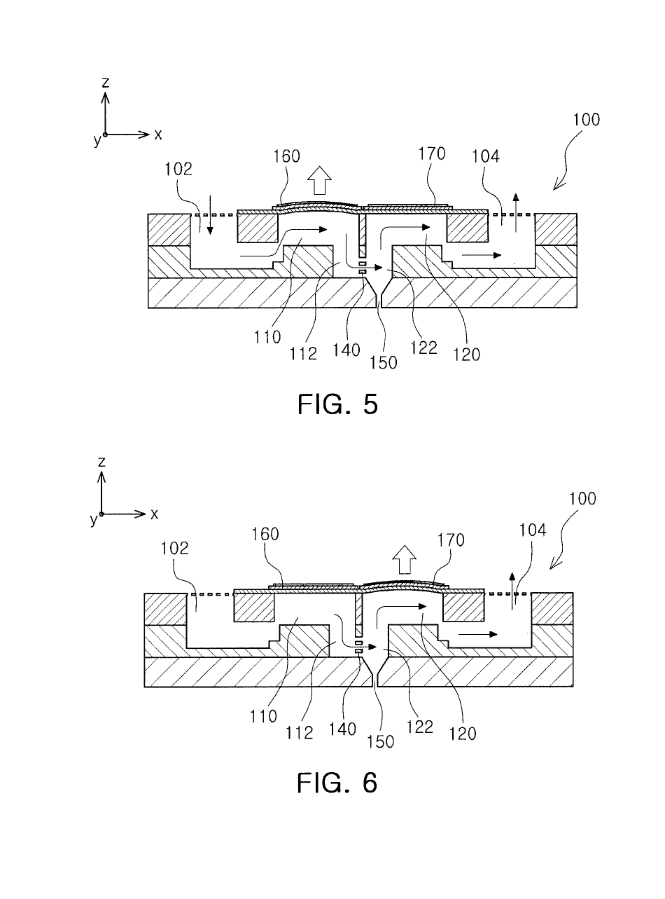

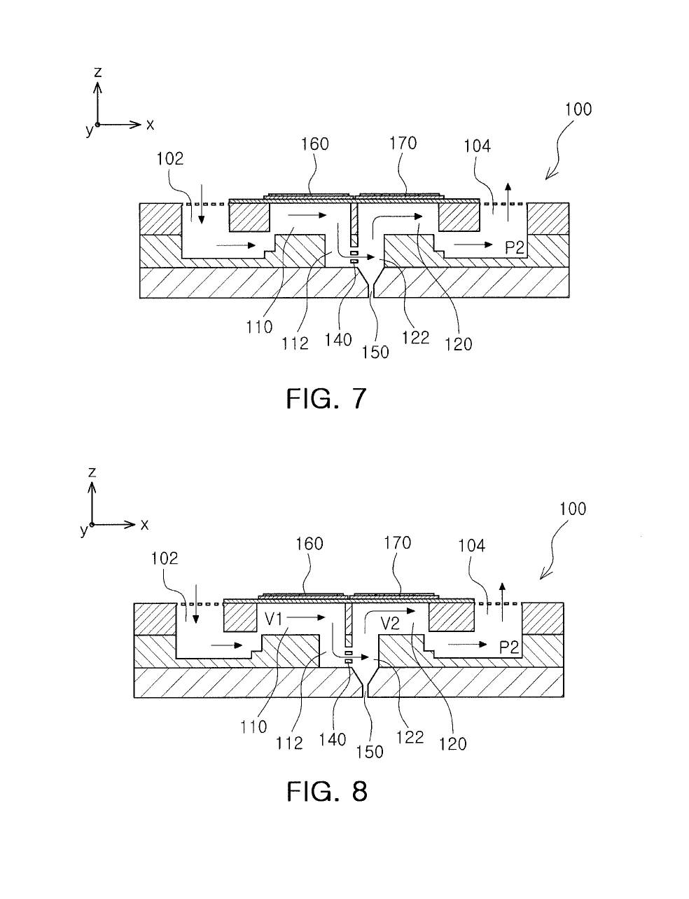

Meanwhile, in a process in which the first actuator 160 returns to an original state thereof, when negative pressure is applied to the first pressure chamber 110 (see FIG. 5), the ink in the first common channel 102 may be introduced into the first pressure chamber 110. Similarly, in a process in which the second actuator 170 returns to an original state thereof, when negative pressure is applied to the second pressure chamber 120 (see FIG. 6), the ink may be moved from the first pressure chamber 110 to the second pressure chamber 120. Thereafter, when the actuators 160 and 170 entirely return to normal state, the state in which the first pressure chamber 110 and the second pressure chamber 120 are filled with the ink may be maintained as shown in FIG. 7.

Hereinafter, further embodiments of the present invention will be described. For reference, in the following embodiments, the same reference numerals will be used to describe the same components as those of the first embodiment. In addition, a detailed description of the same components will be omitted.

An inkjet print head according to a second embodiment of the present invention will be described with reference to FIG. 8.

The inkjet print head 100 according to the second embodiment of the present invention may be distinguished from that of the first embodiment in that the first pressure chamber 110 and the second pressure chamber 120 have different volumes.

In order to smoothly move the ink from the first common channel 102 to the second common channel 104, the first pressure chamber 110 needs to have a higher pressure than that of the second pressure chamber 120. In consideration of this fact, according to the present embodiment, the first pressure chamber 110 may be formed to have a volume V1 larger than a volume V2 of the second pressure chamber 120.

In the inkjet print head 100 configured as described above, the volume V1 of the first pressure chamber 110 is larger than the volume V2 of the second pressure chamber 120, whereby the pressure of the first pressure chamber 110 may be higher than the pressure of the second pressure chamber 120 in a stopped state (a state in which the actuators are not operated). Therefore, in the present embodiment, the phenomenon in which the ink in the second pressure chamber 120 backwardly flows to the first pressure chamber 110 may be effectively prevented and the ink may tend to move from the first pressure chamber 110 to the second pressure chamber 120.

An inkjet print head according to a third embodiment of the present invention will be described with reference to FIG. 9.

The inkjet print head 100 according to the third embodiment of the present invention may be distinguished from those of the above described embodiments in that the first actuator 160 and the second actuator 170 have different sizes. More specifically, the first actuator 160 may be larger than the second actuator 170. For example, the first actuator 160 may be longer than the second actuator 170 or may have driving force greater than that of the second actuator 170.

In the inkjet print head 100 configured as described above, the pressure formed in the first pressure chamber 110 is higher than the pressure formed in the second pressure chamber 120 when the actuators 160 and 170 are operated, whereby the ink may be effectively moved from the first pressure chamber 110 to the second pressure chamber 120.

An inkjet print head according to a fourth embodiment of the present invention will be described with reference to FIG. 10.

The inkjet print head 100 according to the fourth embodiment of the present invention may be distinguished from those of the above described embodiments in terms of the number of pressure chambers. More specifically, the inkjet print head 100 may include first, second, and third pressure chambers 110, 120, and 130. In addition, the inkjet print head 100 may include first, second, and third actuators 160, 170, and 180 corresponding to the pressure chambers 110, 120, and 130, respectively.

Here, the first pressure chamber 110, the second pressure chamber 120, and the third pressure chamber 130 may have the same volume or may have different volumes. Alternatively, the third pressure chamber 130 may have the volume smaller than that of the first pressure chamber 110 or the second pressure chamber 120.

Similarly, the first actuator 160, the second actuator 170, and the third actuator 180 may have the same size or may have different sizes. Alternatively, the third actuator 180 may have the size less than that of the second actuator 170 or the first actuator 160.

Meanwhile, the inkjet print head 100 according to the present embodiment may have the nozzle 150 formed in the second pressure chamber 120 or the third pressure chamber 130. However, a position of the nozzle 150 may be changed as necessary.

The inkjet print head 100 configured as described above includes the plurality of pressure chambers 110, 120 and 130 and the plurality of actuators 160, 170 and 180, whereby the ink may effectively flow in a direction from the first common channel 102 to the second common channel 104.

An operation of the inkjet print head according to the fourth embodiment of the present invention will be described with reference to FIGS. 11 through 15.

The inkjet print head 100 according to the fourth embodiment of the present invention may allow the first actuator 160 and the second actuator 170 to be operated at different time points. For example, the first actuator 160 may initially be operated and then the second actuator 170 and the third actuator 180 may be simultaneously operated, as shown in FIGS. 11 through 15.

However, the order of operating the actuators 160, 170 and 180 is not limited thereto. That is, the order of operating the actuators 160, 170 and 180 may be changed as necessary. For example, the first actuator 160, the second actuator 170, and the third actuator 180 may be sequentially operated.

The inkjet print head 100 configured as described above may subdivide the pressure chambers into a space in which the ink is discharged (the second pressure chamber 120 based on FIG. 10) and a space in which the ink moves (the first pressure chamber 110 and the third pressure chamber 130 based on FIG. 10). Therefore, according to the present embodiment, the ink is allowed to circulate smoothly while the ink discharge characteristics are improved.

As set forth above, an inkjet print head according to embodiments of the present invention allows ink to be continuously circulated, whereby the ink discharge characteristics and efficiency thereof may be improved.

While the present invention has been shown and described in connection with the embodiments, it will be apparent to those skilled in the art that modifications and variations can be made without departing from the spirit and scope of the invention as defined by the appended claims.

What is claimed is:

1. An inkjet print head, comprising:
a first pressure chamber connected to a first common channel;
a second pressure chamber connected to a second common channel;
a connection channel connecting the first pressure chamber to the second pressure chamber; and
a nozzle formed in the first pressure chamber or the second pressure chamber.

2. The inkjet print head of claim 1, wherein the first pressure chamber and the second pressure chamber are serially connected to one another.

3. The inkjet print head of claim 1, wherein the first pressure chamber and the second pressure chamber have different volumes.

4. The inkjet print head of claim 1, further comprising:
a first actuator generating pressure in the first pressure chamber; and
a second actuator generating pressure in the second pressure chamber.

5. The inkjet print head of claim 4, wherein the first actuator and the second actuator have different sizes.

6. The inkjet print head of claim 1, wherein the first common channel is connected to an ink supplying part, and
the second common channel is connected to an ink recovering part.

7. The inkjet print head of claim 6, the ink supplying part and the ink recovering part are connected to one another so that ink is circulated therebetween.

8. An inkjet print head, comprising:
a first pressure chamber connected to a first common channel;
a second pressure chamber connected to a second common channel;
a third pressure chamber connected to the first pressure chamber and the second pressure chamber; and
a nozzle formed in the third pressure chamber.

9. The inkjet print head of claim 8, wherein the third pressure chamber has a different volume from that of the first pressure chamber or the second pressure chamber.

10. The inkjet print head of claim 8, further comprising:
a first actuator generating pressure in the first pressure chamber;
a second actuator generating pressure in the second pressure chamber; and
a third actuator generating pressure in the third pressure chamber.

11. The inkjet print head of claim 10, wherein the third actuator has a different size from that of the first actuator or the second actuator.

12. The inkjet print head of claim 8, wherein the first common channel is connected to an ink supplying part, and
the second common channel is connected to an ink recovering part.

13. The inkjet print head of claim 12, wherein the ink supplying part and the ink recovering part are connected to one another so that ink is circulated therebetween.
